(19) United States
(12) Patent Application Publication
(10) Pub. No.: US 2017/0185422 A1
(43) Pub. Date: Jun. 29, 2017

(54) METHOD AND SYSTEM FOR GENERATING AND CONTROLLING COMPOSITE USER INTERFACE CONTROL

(71) Applicants: Le Holdings (Beijing) Co., Ltd., Beijing (CN); Le Shi Zhi Xin Electronic Technology (Tianjin) Limited, Binhai New Area (CN)

(72) Inventor: Shen Li, Binhai New Area (CN)

(21) Appl. No.: 15/242,751

(22) Filed: Aug. 22, 2016

Related U.S. Application Data
(63) Continuation of application No. PCT/CN2016/089568, filed on Jul. 10, 2016.

(30) Foreign Application Priority Data
Dec. 28, 2015 (CN) 201511014473.8

(51) Int. Cl. G06F 9/44

(52) U.S. Cl. CPC G06F 9/4443; G06F 3/0482

(57) ABSTRACT

Embodiments of the present disclosure relate to the field of multimedia technologies and disclose methods for generating and controlling a composite user interface control and an electronic device. The method for generating a composite user interface control includes the following steps: creating at least one composite control, where the composite control includes at least two subcontrols; adding each subcontrol to the composite control; respectively setting a general attribute and a unique attribute of each subcontrol; acquiring a resource of each subcontrol and transmitting the resource to a corresponding subcontrol; and adding an event response mechanism to the composite control. In some embodiments of the present disclosure, the method for generating a composite user interface control may enable a manner for generating a user interface control to be relatively simple, which facilitates control over and modification on all user interface controls or a single user interface control on a user interface.

### CROSS-REFERENCE TO RELATED APPLICATIONS

This disclosure is a continuation of PCT application No. PCT/CN2016/089568 submitted on Jul. 10, 2016. This application claims priority to Chinese Patent Application No. 201511014473.8, filed with the Chinese Patent Office on Dec. 28, 2015 and entitled “METHOD AND SYSTEM FOR GENERATING AND CONTROLLING COMPOSITE USER INTERFACE CONTROL”, which is incorporated herein by reference in its entirety.

### TECHNICAL FIELD

This patent disclosure relates to the field of multimedia technologies, and in particular, to a method for generating a composite user interface control and an electronic device in a multimedia technology field.

### BACKGROUND

With constant development of science and technology and constant progress of a multimedia technology, application software for video playback is richer in variety and more powerful in function. A user may install a video application in a mobile terminal and then watch a video by using the video application. Moreover, with development of Internet infrastructure and with a network speed improved and Internet access costs reduced, more users watch videos by using mobile terminal on the Internet. A video application may play a great number of videos for a user. For example, the user may watch a live program, a match, or a television program by using the video application.

In the process of implementing the present disclosure, the inventor finds that various controls, for example, an application icon corresponding to an application already installed on a video playback device, are displayed on a video playback interface. A video player device commonly used in life of people: intelligent TV is used as an example. The present intelligent TV generally perform selection and an operation on a control on an interface by using only a remote-control device. For example, a remote-control device is used to select one application icon, to enter an application required by a user. However, in actual application, a user may have various operation requirements, for example, control movement, control management, and viewing movie remarks, on a control on an interface. Moreover, currently, there are many UI (UI is an abbreviation of User Interface, and is yong hu jie mian in Chinese) controls related to movie information in a virtual reality application based on a mobile phone. However, a conventional method for implementing a UI control is relatively tedious and redundant. In the conventional method, generally, a single control (for example, a poster, a movie name, information about a brief introduction to a movie, and an interaction manner between the above controls and a user) for presenting movie information is independently created in a UI menu of a scenario according to a requirement on a quantity of presented movies in the specific scenario. In addition, the foregoing controls are generally highlighted when selected, or movie playback is clicked when a movie needs to be played. Styles of UI interfaces are not unified, thereby affecting user experience.

### SUMMARY

The present disclosure provides a method for generating a composite user interface control and an electronic device, so that a manner for generating a user interface control is relatively simple, which benefits control over and modification on all user interface controls or a single user interface control on a user interface. Therefore, a set of user interface can be reused in multiple scenarios, thereby unifying styles of an entire application program on user interfaces, improving user experience, and avoiding an error caused by repeated developing of a user interface control.

According to a first aspect, an embodiment of this disclosure provides a method for generating a composite user interface control, which is applied to an electronic device, including the following steps: creating at least one composite control, where the composite control includes at least two subcontrols; adding each subcontrol to the composite control; respectively setting a general attribute and a unique attribute of each subcontrol; acquiring a resource of each subcontrol and transmitting the resource to a corresponding subcontrol; and adding an event response mechanism to the composite control.

According to a second aspect, an embodiment of this disclosure further provides a non-volatile computer storage medium, which stores computer executable instructions, where the computer executable instructions are used to enable, when executed by at least one processor, the processor to execute any foregoing method for generating a composite user interface control.

According to a third aspect, an embodiment of this disclosure further provides an electronic device, including: at least one processor; and a memory. The memory stores a program that can be executed by the at least one processor, and the program is executed by the at least one processor, so that the at least one processor can execute any foregoing method for generating a composite user interface control of this disclosure.

According to the method for generating a composite user interface control and the electronic device provided in the embodiments of this disclosure, at least one composite control is created, and each subcontrol included in the composite control is added to the composite control, so that subcontrols corresponding to a same movie may be integrated into one composite control, that is, subcontrols corresponding to a same movie may be generated at a time, and used as a composite control and provided in a corresponding scenario menu to a user for direct use, so that multiple movies with same or similar movie information can be presented in different scenario menus, and a manner for generating a user interface control is relatively simple, which benefits control over and modification on all controls or a single control on a user interface and avoids an error caused by repeated developing of a user interface control. In addition, a set of user interface can be reused in multiple scenarios, thereby unifying styles of an entire application program on user interfaces and improving user experience.

In an embodiment, a general attribute and a unique attribute of each subcontrol is respectively set; a resource of each subcontrol is acquired, and the resource is transmitted to a corresponding subcontrol; and an event response mechanism is added to the composite control. A preset operation event is acquired; and a unique attribute of a subcontrol, which responds to the preset operation, in a composite control according to the acquired preset operation, so that manners for modifying and controlling a unique attribute of each subcontrol are relatively simple, and errors in actual development or an operation process can be greatly reduced.

In an embodiment, the step of adding each subcontrol to the composite control includes the following substeps: performing position arrangement on each subcontrol; and allocating a serial number to each subcontrol. Therefore, a layout of subcontrols is well organised, and relatively good user experience is obtained.

In an embodiment, after the step of adding each subcontrol to the composite control, the method further includes the following steps: obtaining a serial number of a subcontrol by using the composite control; and controlling or modifying, according to the serial number of the subcontrol, the subcontrol corresponding to the serial number. In such a manner, types of information of a movie are in a one-to-one correspondence to subcontrols of a user interface, so that it is more convenient to perform management, and code is clearer, which facilitates developing and designing of a designer. Moreover, controlling or modifying a subcontrol corresponding to a serial number of the subcontrol is convenient, so that control over or modification on each subcontrol is relatively simple and accurate, which can avoid an error.

In an embodiment, before the step of creating at least one composite control, the method further includes the following steps: creating a menu container for different scenarios; and after the step of creating at least one composite control and before the step of adding each subcontrol to the composite control, adding the created composite control to the menu container. In the foregoing manner, one or more composite controls may be added to a menu container in different scenarios, thereby presenting movie information in different perspectives. Moreover, categorization storage and management can be performed on each composite control, which greatly improves reusability of a figure engine for developing a virtual reality application. A set of user interface is reused in multiple scenarios, thereby unifying styles of an APP on user interfaces, reducing a rate of an error caused during developing, and reducing work load.

In an embodiment, the subcontrol is any one of the following: a static-picture control, a static-word control, and a button control. Therefore, static picture information, static word information, or operation and control information corresponding to a button of a movie may be acquired.

In an embodiment, a general attribute of the static-picture control is a picture resource; and a unique attribute of the static-picture control includes: visibility, a picture serial number, and a size of the picture resource; a general attribute of the static-word control is a word resource; and a unique attribute of the static-word control includes: visibility, single-line display, multi-line display, and circular transparency change and position change; and a general attribute of the button control is a picture resource and an event response; and a unique attribute of the button control includes: highlight display and mode switch.

In an embodiment, in the step of acquiring a preset operation event, the composite control acquires the preset operation event and transmits the preset operation event to the subcontrol; or the subcontrol acquires the preset operation event and transmits the preset operation event to the composite control; or both the composite control and the subcontrol acquire the preset operation event and transmit the preset operation event to each other. The preset operation event may be acquired in any manner according to a requirement of a developer, so that a manner for acquiring a preset operation event is diversified, thereby meeting requirements of different designers.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same numerical reference marks in the accompanying drawings are similar elements. Unless otherwise particularly stated, the figures in the accompanying drawings do not form a scale limitation.

FIG. 1 is a flowchart of a method for generating a composite user interface control according to Embodiment 1 of this disclosure;

FIG. 2 is a schematic diagram of position arrangement of subcontrols on a user interface according to Embodiment 1 of this disclosure;

FIG. 3 is a block diagram of a system for generating a composite user interface control according to Embodiment 2 of this disclosure;

FIG. 4 is a flowchart of an event response of a method for controlling a composite user interface control according to Embodiment 3 of this disclosure;

FIG. 5 is a schematic structural diagram of an electronic device according to Embodiment 7 of this disclosure; and

FIG. 6 is a schematic structural diagram of an electronic device according to Embodiment 8 of this disclosure.

### DETAILED DESCRIPTION

To make the objective, technical solution, and advantages of this disclosure clearer, the following clearly and completely describes the technical solution of this disclosure with reference to the accompanying drawings in embodiments of this disclosure by using implementation manners. Apparently, the described embodiments are some rather than all of the embodiments of this disclosure.

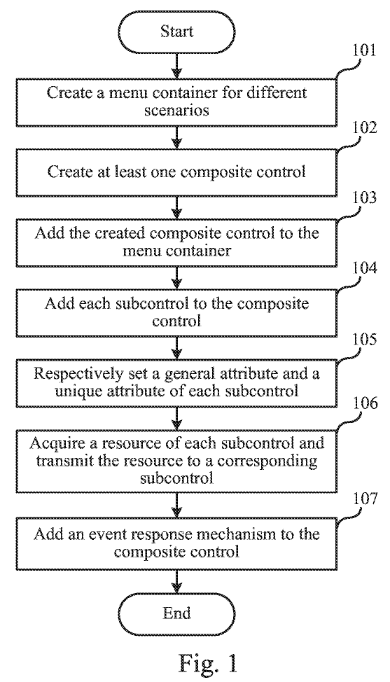

Embodiment 1 of the present disclosure relates to a method for generating a composite user interface control. A specific process is shown in FIG. 1 and includes the following steps:

Step 101: Create a menu container for different scenarios.

By using a menu container, a requirement that multiple movies with a same or similar movie information type are presented on control menus in different scenario can be met, and unity of UI styles (UI is an abbreviation of User Interface, and is yong hu jie mian in Chinese) can also be maintained, which greatly improves reusablity of a virtual reality application. A set of user interface is reused in multiple scenarios, thereby unifying styles of an APP (APP is an abbreviation of application and is ying yong cheng xu in Chinese) on user interfaces and avoiding an error caused by repeated developing.

Step 102: Create at least one composite control.

By using a composite control, subcontrols corresponding to a same movie may be integrated into one composite control, that is, subcontrols corresponding to a same movie may be generated at a time, and used as a composite control and provided in a corresponding scenario menu to a user for direct use. In addition, using a composite control also benefits control over and modification on all controls or a single control on a user interface, and avoids an error caused by repeated developing of a user interface control.

It should be noted that, the composite control may include at least two subcontrols, and the subcontrol may be any one of the following: a static picture control, a static word control, and a button control. For example, if an application scenario is a video playback scenario of an intelligent TV, the static picture control may correspond to a poster picture, the static word control may correspond to movie name words and brief introduction words, and the button control may correspond to an interaction button.

Step 103: Add the created composite control to the menu container.

Step 104: Add each subcontrol to the composite control.

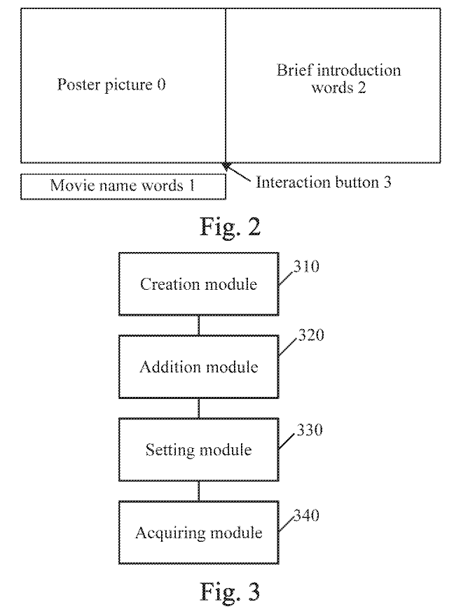

Specifically, position arrangement may be performed on each subcontrol, and a serial number is allocated to each subcontrol. For example, in FIG. 2, the static picture control is a poster picture, and a serial number of the poster picture is marked as 0. The static word control may be movie name words and brief introduction words, and serial numbers of movie name words and brief introduction words are respectively marked as 1 and 2. The button control is an interaction button, and a serial number of the interaction button is marked as 3. The poster picture 0 is arranged at the topleft corner of an interface, and the brief introduction words 2 are arranged at the topright corner of the interface. The poster picture 0 and the brief introduction words 2 are arranged in parallel at an upper part of the interface. A lower part of the interface corresponds to a position below the poster picture 0, and the movie name words 1 are arranged at the lower part of the interface. In addition, the interaction button 3 is arranged at an overlapped area of the brief introduction words 2 and the poster picture 0. It should be noted that, position arrangement is performed on the other subcontrols according to a resource picture size of the poster picture 0, and there is an interval between subcontrols.

Step 105: Respectively set a general attribute and a unique attribute of each subcontrol.

When a subcontrol is a static picture control, a general attribute of the static picture control is set to picture resource. A unique attribute of the static picture control includes: visibility, a picture serial number, and a size of a picture resource.

When a subcontrol is a static word control, a general attribute of the static word control is set to word resource. A unique attribute of the static word control includes: visibility, single-line display, multi-line display, and circular transparency change and position change. For example, when the static word control is the movie name words 1, a character string needs to be given as a movie name; the movie name words 1 is of a single-line display attribute and is limited by the size of the picture resource in the foregoing static picture control. When a name of the movie name words 1 is excessively long, the movie name words 1 are presented in a marquee-like manner. Therefore, circular transparency change and position animation need to be set for the movie name words 1 in a marquee-like manner. When the static word control is the brief introduction words 2, a character string needs to be given as a brief introduction to a movie; the brief introduction words 2 are of a multi-line display attribute. When the poster picture 0 is focused and highlighted, the brief introduction words 2 start to be displayed. Therefore, visibility animation needs to be set for the brief introduction words 2.

When a subcontrol is a button control, a general attribute of the button control is set to picture resource and event response. A unique attribute of the button control includes: highlight display and mode switch. When focused and highlighted, the interaction button 3 may be used to switch the poster picture 0. When the interaction button 3 is clicked, a movie playback mode may be entered. Therefore, the interaction button 3 may be used to turn off a menu or switch a scenario.

Step 106: Acquire a resource of each subcontrol and transmit the resource to a corresponding subcontrol.

A picture resource is read and correspondingly transmitted to the poster picture 0 and the interaction button 3. A word resource is read and correspondingly transmitted to the movie name words 1 and the brief introduction words 2. For example, a size of the poster picture 0 is acquired, the size of the poster picture 0 is marked as Imgwidth (Imgwidth is to pian kuang du in Chinese), and Imgwidth is transmitted to a corresponding static picture control. A length of a character string of the movie name words 1 is acquired, and the length is transmitted to a static word control. If the length of the character string of the movie name words is greater than Imgwidth, the movie name words 1 are set to be presented in a marquee-like manner. If the length of the character string of the movie name words is less than Imgwidth, the movie name words 1 are normally displayed in a single line.

Step 107: Add an event response mechanism to the composite control.

Event response mechanisms of existing subcontrols all can be used in the present disclosure, and details are not described herein. Different event response mechanisms may be set according to different scenario requirements. For example, displaying is performed in highlight mode when a subcontrol is focused (a border picture of a button is switched); and a movie playback mode is entered when a subcontrol is clicked (turn off a menu and switch a scenario).

In addition, it should be noted that, when a subcontrol needs to be controlled or modified, a serial number of the subcontrol may be obtained by using a composite control. The subcontrol corresponding to the serial number is controlled or modified according to the serial number of the subcontrol. For example, a serial number of the static word control may be obtained, and attributes of the circular transparency change and position change of the static word control are modified, thereby achieving a marquee effect. Because types of information of a movie are in a one-to-one correspondence to subcontrols of a user interface, controlling or modifying, according to a serial number of a subcontrol, the subcontrol corresponding to the serial number facilitates management on each subcontrol. Moreover, in a designing process, code is clearer, which facilitates developing and designing of a developer. In addition, controlling or modifying the subcontrol corresponding to a serial number of the subcontrol is convenient, so that control over or modification on each subcontrol is relatively simple and accurate, which can avoid an error.

In the implementation manner, at least one composite control is created, and each subcontrol included in the composite control is added to the composite control, so that subcontrols corresponding to a same movie may be integrated into one composite control, that is, subcontrols corresponding to a same movie may be generated at a time, and used as a composite control and provided in a corresponding scenario menu to a user for direct use, so that multiple movies with same or similar movie information can be presented in different scenario menus. Therefore, a set of user interface can be reused in multiple scenarios, thereby unifying styles of an entire application program on user interfaces and improving user experience. Further, a general attribute and a unique attribute of each subcontrol is respectively set; a resource of each subcontrol is acquired, and the resource is transmitted to a corresponding subcontrol; and an event response mechanism is added to the composite control, so that a manner for generating a user interface control is relatively simple, which benefits control over and modification on all controls or a single control on a user interface and avoids an error caused by repeated developing of a user interface control.

In addition, it should be noted that, in an actual application based on virtual reality, there is a virtual reality three-dimensional figure engine to develop functions of a figure. Meanwhile, there is a movie information management mechanism, to guarantee that movie information presented on a UI interface is in a one-to-one correspondence to movie information in a database. Therefore, a composite control type is added to the figure engine, and interfaces for basic 3D UI controls and a movie database and functions of the composite control type are provided, which can implement fast developing of multi-movie presentation, and greatly simplify a tedious process of creating a 3D control related to movie information presentation in a scenario.

Embodiment 2 of the present disclosure relates to a system for generating a composite user interface control, as shown in FIG. 3, including a creation module 310, an addition module 320, a setting module 330, and an acquiring module 340, where the creation module 310 is configured to create at least one composite control, where the composite control includes at least two subcontrols; the addition module 320 is configured to add each subcontrol to the composite control; the setting module 330 is configured to respectively set a general attribute and a unique attribute of each subcontrol, and add an event response mechanism to the composite control; and the acquiring module 340 is configured to acquire a resource of each subcontrol and transmit the resource to a corresponding subcontrol.

It is easy to find that, the implementation manner is a system embodiment corresponding to Embodiment 1. The implementation manner and Embodiment 1 can be implemented by cooperating with each other. Related technical details described in the Embodiment 1 are still valid in the implementation manner. To reduce repetition, details are not described herein again. Correspondingly, related technical details described in the implementation manner can also be applied to Embodiment 1.

It should be noted that, all modules involved in the implementation manner are logic modules. In actual application, a logic unit may be a physical unit, or may be a part of a physical unit; or may be implemented by a combination of multiple physical units. In addition, to underline the innovative part of the present disclosure, in the implementation manner, a unit not closely related to resolving of a technical problem put forward in the present disclosure is not described, but it does not indicate that there is another unit in the implementation manner.

Embodiment 3 of the present disclosure relates to a method for controlling a composite user interface control. The composite control involved in the method is created by using the method for generating a composite user interface control in Embodiment 1. The method for controlling a composite control includes the following steps:

A preset operation event is acquired. In the step, a composite control may acquire a preset operation event, and transmit the preset operation event to a subcontrol. Alternatively, a subcontrol may acquire a preset operation event, and transmit the preset operation event to a composite control. Alternatively, both a composite control and a subcontrol can acquire a preset operation event and transmit the preset operation event to each other. A manner for acquiring a preset operation event is diversified, and therefore, can meet requirements of different designers.

A unique attribute of a subcontrol, which responds to the preset operation, in a composite control is modified according to the acquired preset operation. Current operations on the user interface all can be used in the present disclosure. For example, the preset operation event may be a common focus event or click event.

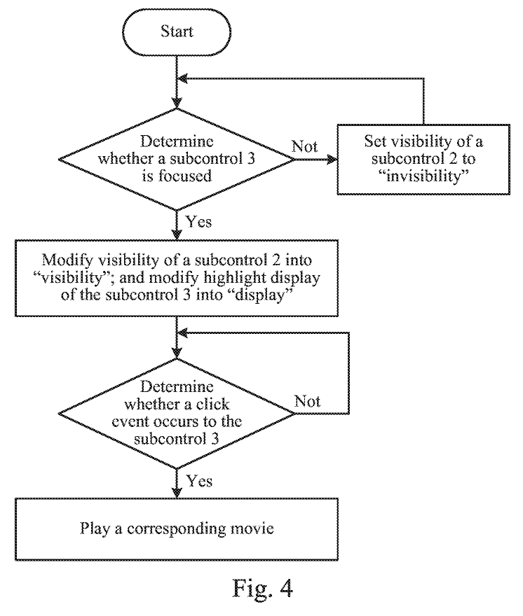

Referring to FIG. 4, if a focus operation (preset duration of a pause operation on a button control) on a button control is detected, and subcontrols (for example, a subcontrol 3 in FIG. 2) responding to the focus event is a multi-line word control (for example, a subcontrol 2 in FIG. 2) and a button control, where unique attributes of the multi-line word control and the button control are respectively visibility and highlight display, when the pause operation is acquired, visibility of the subcontrol 2 is modified from “invisibility” into “visibility”, and highlight display of the subcontrol 3 is modified from “not display (false)” into “display (true)”. If a click operation on a button control is detected, a control responding to the click event is a composite control, where a unique attribute of the composite control is scenario switch and menu on/off, when the pause operation is acquired, a menu is turned off, scenario switch is performed, and a movie playback mode is entered.

In the implementation manner, a preset operation event is acquired; and a unique attribute of a subcontrol, which responds to the preset operation, in a composite control according to the acquired preset operation, so that manners for modifying and controlling a unique attribute of each subcontrol are relatively simple, and errors in actual developing or an operation process can be greatly reduced.

Embodiment 4 of the present disclosure relates to a system for controlling a composite user interface control. The composite control involved in the implementation manner is created by using the system for generating a composite user interface control in Embodiment 2. The system in the implementation manner includes a listening module and a modification module, where the listening module is configured to acquire a preset operation event; the modification module is configured to modify a unique attribute of a subcontrol, which responds to the preset operation, in a composite control according to the acquired preset operation.

Because Embodiment 3 is corresponding to the implementation manner, the implementation manner and Embodiment 3 can be implemented by cooperating with each other. Related technical details described in Embodiment 3 are still valid in the implementation manner. A technical effect achieved in Embodiment 3 can also be achieved in the implementation manner. To reduce repetition, details are not described herein again. Correspondingly, related technical details described in the implementation manner can also be applied to Embodiment 3.

Steps of a method or an algorithm described with reference to the embodiments disclosed in this specification can be directly embodied in hardware, a software module executed by a processor, or a combination of the hardware and the software module. The software module may camp on a random access memory (RAM), a flash memory, a read only memory (ROM), a programmable read only memory (PROM), an erasable read only memory (PROM), an erasable programmable read only memory (EPROM), an electrically erasable programmable read only memory (EEPROM), a register, a hard disk, a removable disk, a compact disc read only memory (CD-ROM), or a storage medium in any other form, which is known in the prior art. In an alternative solution, the storage medium and the processor may be integrated into one. The processor and the storage medium may camp on an application specific integrated circuit (ASIC). The ASIC may camp on a computing apparatus or a user terminal. Alternatively, the processor and the storage medium may camp on a computing apparatus or a user terminal as discrete components.

Embodiment 5 of this disclosure provides a non-volatile computer storage medium. The computer storage medium stores computer executable instructions, where the computer executable instructions can execute the method for generating a composite user interface control in any one of the foregoing method embodiments.

Embodiment 6 of this disclosure provides a non-volatile computer storage medium, which stores computer executable instructions, where the computer executable instructions can execute the method for controlling a composite user interface control in any one of the foregoing method embodiments.

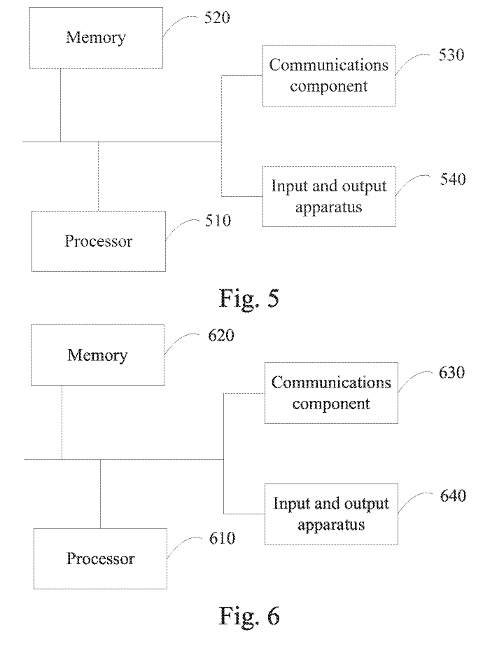

FIG. 5 is a schematic structural diagram of hardware of an electronic device for performing a method for generating a composite user interface control according to Embodiment 7 of this disclosure. As shown in FIG. 5, the device includes:

one or more processors 510 and a memory 520, where only one processor 510 is used as an example in FIG. 5.

The electronic device for performing the method for generating a composite user interface control may further include: a communications component 530 and an input and output apparatus 540.

The processor 510, the memory 520, the communications component 530, and the input and output apparatus 540 can be connected by means of a bus or in other manners. A connection by means of a bus is used as an example in FIG. 5.

As a non-volatile computer readable storage medium, the memory 520 can be used to store non-volatile software programs, non-volatile computer executable programs and modules, for example, program instructions/module corresponding to the method for generating a composite user interface control in the embodiments of this disclosure (for example, the creation module 310, the addition module 320, the setting module 330, and the acquiring module 340 shown in FIG. 3). The processor 510 executes various functional applications and data processing of the server, that is, implements the method for generating a composite user interface control in the foregoing method embodiments, by running the non-volatile software programs, instructions, and modules that are stored in the memory 520.

The memory 520 may include a program storage area and a data storage area, where the program storage area may store an operating system and an application program that is needed by at least one function; the data storage area may store data created according to use of the unlocking apparatus, and the like. In addition, the memory 520 may include a high-speed random access memory, or may also include a non-volatile memory such as at least one disk storage device, flash storage device, or another non-volatile solid-state storage device. In some embodiments, the memory 520 optionally includes memories that are remotely disposed with respect to the processor 510, and the remote memories may be connected, via a network, to the server. Examples of the foregoing network include but are not limited to: the Internet, an intranet, a local area network, a mobile communications network, or a combination thereof.

The communications component 530 is configured to implement a wireless or wired communications function of the electronic device, so that the electronic device can interact with a server, to simultaneously receive data of a to-be-displayed video in the server in real time.

The input and output apparatus 540 may include a display device, for example, a display screen. The display screen may be a touchscreen, configured to control and modify a control, display a UI interface, and the like.

The one or more modules are stored in the memory 520; when the one or more modules are executed by the one or more processors 510, the method for generating a composite user interface control in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

FIG. 6 is a schematic structural diagram of hardware of an electronic device for performing a method for controlling a composite user interface control according to Embodiment 8 of this disclosure. As shown in FIG. 6, the device includes:

one or more processors 610 and a memory 620, where only one processor 610 is used as an example in FIG. 6.

The electronic device for performing the method for controlling a composite user interface control may further include: a communications component 630 and an input and output apparatus 640.

The processor 610, the memory 620, the communications component 630, and the input and output apparatus 640 can be connected by means of a bus or in other manners. A connection by means of a bus is used as an example in FIG. 6.

As a non-volatile computer readable storage medium, the memory 620 can be used to store non-volatile software programs, non-volatile computer executable programs and modules, for example, program instructions/module corresponding to the method for controlling a composite user interface control in the embodiments of this disclosure. The processor 610 executes various functional applications and data processing of the server, that is, implements the method for controlling a composite user interface control in the foregoing method embodiments, by running the non-volatile software programs, instructions, and modules that are stored in the memory 620.

The memory 620 may include a program storage area and a data storage area, where the program storage area may store an operating system and an application program that is needed by at least one function; the data storage area may store data created according to use of the unlocking apparatus, and the like. In addition, the memory 620 may include a high-speed random access memory, or may also include a non-volatile memory such as at least one disk storage device, flash storage device, or another non-volatile solid-state storage device. In some embodiments, the memory 620 optionally includes memories that are remotely disposed with respect to the processor 610, and the remote memories may be connected, via a network, to the server. Examples of the foregoing network include but are not limited to: the Internet, an intranet, a local area network, a mobile communications network, or a combination thereof.

The communications component 630 is configured to implement a wireless or wired communications function of the electronic device, so that the electronic device can interact with a server, to simultaneously receive data of a to-be-displayed video in the server in real time.

The input and output apparatus 640 may include a display device, for example, a display screen. The display screen may be a touchscreen, configured to detect a focus operation in button space, display a control, and the like.

The one or more modules are stored in the memory 620; when the one or more modules are executed by the one or more processors 610, the method for controlling a composite user interface control in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a functional mobile phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(6) other electronic apparatuses having a data interaction function.

The apparatus embodiment described above is merely exemplary, and units described as separated components may be or may not be physically separated; components presented as units may be or may not be physical units, that is, the components may be located in a same place, or may also be distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, or the like) to perform the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions recorded in the foregoing embodiments, or make equivalent replacements to some technical features therein; however, the modifications or replacements do not make the essence of corresponding technical solutions depart from the spirit and scope of the technical solutions of the embodiments of this disclosure.

1. A method for generating a composite user interface control, which is applied to an electronic device, comprising the following steps:
creating at least one composite control, wherein the composite control comprises at least two subcontrols;
adding each subcontrol to the composite control;
respectively setting a general attribute and a unique attribute of each subcontrol;
acquiring a resource of each subcontrol and transmitting the resource to a corresponding subcontrol; and
adding an event response mechanism to the composite control.

2. The method for generating a composite user interface control according to claim 1, wherein the step of adding each subcontrol to the composite control comprises the following substeps:
performing position arrangement on each subcontrol; and
allocating a serial number to each subcontrol.

3. The method for generating a composite user interface control according to claim 2, after the step of adding each subcontrol to the composite control, further comprising the following steps:
obtaining a serial number of a subcontrol by using the composite control; and
controlling or modifying, according to the serial number of the subcontrol, the subcontrol corresponding to the serial number.

4. The method for generating a composite user interface control according to claim 1, before the step of creating at least one composite control, further comprising the following steps:
creating a menu container for different scenarios; and
after the step of creating at least one composite control and before the step of adding each subcontrol to the composite control, adding the created composite control to the menu container.

5. The method for generating a composite user interface control according to claim 1, wherein the subcontrol is any one of the following:
a static-picture control, a static-word control, and a button control.

6. The method for generating a composite user interface control according to claim 5, wherein
a general attribute of the static-picture control is a picture resource; and
a unique attribute of the static-picture control comprises: visibility, a picture serial number, and a size of a picture resource;
a general attribute of the static-word control is a word resource; and
a unique attribute of the static-word control comprises: visibility, single-line display, multi-line display, and circular transparency change and position change; and
a general attribute of the button control is a picture resource and an event response; and
a unique attribute of the button control comprises: highlight display and mode switch.

7-11. (canceled)

12. A non-volatile computer storage medium, which stores computer executable instructions, that when executed by an electronic device, cause the electronic device to:
create at least one composite control, wherein the composite control comprises at least two subcontrols;
add each subcontrol to the composite control;
respectively set a general attribute and a unique attribute of each subcontrol;
acquire a resource of each subcontrol and transmitting the resource to a corresponding subcontrol; and
add an event response mechanism to the composite control.

13. The non-volatile computer storage medium according to claim 12, wherein the instructions to add each subcontrol to the composite control cause the electronic device to:
perform position arrangement on each subcontrol; and
allocate a serial number to each subcontrol.

14. The non-volatile computer storage medium according to claim 13, wherein the instructions to add each subcontrol to the composite control, further cause the electronic device to:
obtain a serial number of a subcontrol by using the composite control; and
control or modifying, according to the serial number of the subcontrol, the subcontrol corresponding to the serial number.

15. The non-volatile computer storage medium according to claim 12, wherein before the instructions to create at least one composite control, further cause the electronic device to:
create a menu container for different scenarios; and
after the instructions to create at least one composite control and before the instructions to add each subcontrol to the composite control, add the created composite control to the menu container.

16. The non-volatile computer storage medium according to claim 12, wherein the subcontrol is any one of the following:
a static-picture control, a static-word control, and a button control.

17. The non-volatile computer storage medium according to claim 16, wherein a general attribute of the static-picture control is a picture resource; and
a unique attribute of the static-picture control comprises: visibility, a picture serial number, and a size of a picture resource;
a general attribute of the static-word control is a word resource; and
a unique attribute of the static-word control comprises: visibility, single-line display, multi-line display, and circular transparency change and position change; and
a general attribute of the button control is a picture resource and an event response; and
a unique attribute of the button control comprises: highlight display and mode switch.

18. An electronic device, comprising:
at least one processor; and
a memory that performs communication with and is connected to the at least one processor, wherein
the memory stores instructions that can be executed by the at least one processor, and the instructions are executed by the at least one processor, so that the at least one processor to:
create at least one composite control, wherein the composite control comprises at least two subcontrols;
add each subcontrol to the composite control;
respectively set a general attribute and a unique attribute of each subcontrol;
acquire a resource of each subcontrol and transmit the resource to a corresponding subcontrol; and
add an event response mechanism to the composite control.

19. The electronic device according to claim 18, wherein the execution of the instructions to add each subcontrol to the composite control, the instructions cause the at least one processor to:
perform position arrangement on each subcontrol; and
allocate a serial number to each subcontrol.

20. The electronic device according to claim 19, wherein after the execution of the instructions to add each subcontrol to the composite control, the instructions are further cause the at least one processor to:
obtain a serial number of a subcontrol by using the composite control; and
control or modify, according to the serial number of the subcontrol, the subcontrol corresponding to the serial number.

21. The electronic device according to claim 18, wherein before the execution of the instructions to create at least one composite control, the instructions are further cause the at least one processor to:
create a menu container for different scenarios; and
after the execution of the instructions to create at least one composite control and before the execution of the instructions to add each subcontrol to the composite control, add the created composite control to the menu container.

22. The electronic device according to claim 18 wherein the subcontrol is any one of the following:
a static-picture control, a static-word control, and a button control.

23. The electronic device according to claim 22, wherein a general attribute of the static-picture control is a picture resource; and
a unique attribute of the static-picture control comprises: visibility, a picture serial number, and a size of a picture resource;
a general attribute of the static-word control is a word resource; and
a unique attribute of the static-word control comprises: visibility, single-line display, multi-line display, and circular transparency change and position change; and
a general attribute of the button control is a picture resource and an event response; and
a unique attribute of the button control comprises: highlight display and mode switch.
